(19) United States
(12) Patent Application Publication
(10) Pub. No.: US 2024/0093036 A1
(43) Pub. Date: Mar. 21, 2024

(54) COMPOSITE PARTICLES

(71) Applicant: TDK CORPORATION, Tokyo (JP)

(72) Inventors: Yuta NAKAGAWA, Tokyo (JP); Takashi INAGAKI, Tokyo (JP)

(73) Assignee: TDK CORPORATION, Tokyo (JP)

(21) Appl. No.: 18/270,694

(22) PCT Filed: Sep. 30, 2021
(86) PCT No.: PCT/JP2021/036147

§ 371 Date: Jun. 30, 2023

(30) Foreign Application Priority Data
Mar. 30, 2021 (JP) 2021-058046

(51) Int. Cl. C09C 3/00; C01B 21/064; C08K 9/06; C09C 1/00; C09C 1/02; C09C 1/24; C09C 1/30; C09C 1/36; C09C 1/40; C09C 1/62; C09C 3/06; C09C 3/12

(52) U.S. Cl. CPC C09C 3/006; C01B 21/0648; C08K 9/06; C09C 1/0006; C09C 1/028; C09C 1/24; C09C 1/3054; C09C 1/3081; C09C 1/309; C09C 1/3692; C09C 1/407; C09C 1/62; C09C 3/063; C09C 3/12; C01P 2004/80

(57) ABSTRACT

A composite particle of the present invention includes an inorganic particle and a graphene oxide particle that coats at least a part of the inorganic particle, and the graphene oxide particle is a modified graphene oxide particle having a surface modified with a hydrocarbon group optionally having a substituent.

### TECHNICAL FIELD

The present invention relates to composite particles.

Priority is claimed on Japanese Patent Application No. 2021-058046, filed in Japan on Mar. 30, 2021, the content of which is incorporated herein by reference.

### BACKGROUND ART

Resin compositions containing inorganic particles dispersed therein are excellent in terms of an insulating property and a heat conductive property and can be used as, for example, materials for circuit boards and the like. For resin compositions containing dissimilar materials such as inorganic particles and a resin, there are cases where the characteristics, such as the heat conductive property, deteriorate when adhesion between the dissimilar materials becomes weak for a reason of voids (pores) generated in the interface between the dissimilar materials. Therefore, in order to guarantee the characteristic development or reliability of the resin compositions, it is important to improve adhesiveness between the inorganic particles and the resin. In order for that, it is effective to treat the surfaces of at least one of the inorganic particles and the resin. In many cases, an organic substance is attached to the inorganic particles by performing a chemical surface treatment, whereby the affinity to the resin is improved. However, some kinds of inorganic particles are chemically stable, and thus there are cases where it is difficult to obtain the effect of chemical surface treatments. In order to improve the affinity of chemically stable inorganic particles to resins, studies are underway regarding the coating of the surfaces of inorganic particles with particles having a high affinity to resins.

Patent Document 1 discloses carbon-modified boron nitride having graphene oxide on the surfaces of boron nitride particles as boron nitride particles having a favorable affinity to resins. In addition, Patent Document 2 discloses a graphene oxide-coated aluminum oxide particle where graphene oxide is present on the surface of the aluminum oxide particle.

### CITATION LIST

### Patent Document

### Patent Document 1

Japanese Unexamined Patent Application, First Publication No. 2019-1701

### Patent Document 2

Japanese Unexamined Patent Application, First Publication No. 2020-117573

### SUMMARY OF INVENTION

### Technical Problem

However, graphene oxide particles generally have a high affinity to water and, sometimes, exhibit a high acidity when coming into contact with moisture in the air. In particular, a carboxy group on the surface of a graphene oxide particle is highly reactive and is likely to react with a basic substance to form a salt. Therefore, when inorganic particles having graphene oxide particles on the surfaces and a resin are dispersed in a solvent together with a basic additive, there are cases where the inorganic particles agglomerate and precipitate in the solvent. Therefore, in a case where inorganic particles having graphene oxide particles on the surfaces are applied to a resin composition, there are limitations on the design of the resin composition such that the use of an acid-resistant resin becomes necessary or the use of a basic additive is not possible.

The present invention has been made in consideration of the above-described problem, and an objective of the present invention is to provide a composite particle containing a graphene oxide particle and an inorganic particle where the acidity of the graphene oxide particle can be kept low and the affinity of the composite particle to resins is high.

### Solution to Problem

As a result of repeating studies in order to solve the above-described problem, the present inventors found that the acidity of the graphene oxide particle can be kept low by modifying the surface of the graphene oxide particle with a hydrocarbon group optionally having a substituent and completed the present invention. That is, a composite particle according to one aspect of the present invention (hereinafter, referred to as the present invention) is as described below.
[1] A composite particle including an inorganic particle and a graphene oxide particles that coat at least a part of the inorganic particle, in which the graphene oxide particles are modified graphene oxide particles having a surface modified with a hydrocarbon group optionally having a substituent.
[2] The composite particle according to [1], in which the inorganic particle includes at least one particle selected from the group consisting of a ceramic particle, a metal particle and a metal oxide particle.
[3] The composite particle according to [1] or [2], in which a coating rate of the graphene oxide particles with respect to the inorganic particle is 80% or more.
[4] The composite particle according to [1] to [3], in which the number of carbon atoms in the hydrocarbon group optionally having a substituent is in a range of 3 or more and 12 or less.
[5] The composite particle according to [1] to [4], in which the hydrocarbon group is a phenyl group.
[6] The composite particle according to [1] to [5], in which the inorganic particle contains at least one element obtained from the group consisting of Li, B, N, Na, Mg, Al, Si, P, K, Ca, Ti, V, Mn, Fe, Co, Ni, Cu, Zu, Sr, Zr, Nb, Ag, Sn, Ba, Bi, Nd and Sm.
[7] The composite particle according to [6], in which the inorganic particle is a particle containing at least one inorganic substance selected from the group consisting of boron nitride, aluminum nitride, aluminum oxide, magnesium oxide and silicon oxide, and the hydrocarbon group optionally having a substituent includes an alkyl group having a glycidoxy group.
[8] The composite particle according to [6], in which the inorganic particle is a particle containing at least one inorganic substance selected from the group consisting of iron oxide, an Fe—Si alloy, an Fe—Ni alloy, an Fe—Si—Al alloy and manganese monoxide, and the hydrocarbon group optionally having a substituent includes a hydrocarbon group or alkyl group having a hydroxy group as a substituent.
[9] The composite particle according to [6], in which the inorganic particle is a particle containing at least one inorganic substance selected from the group consisting of lithium cobalt oxide, lithium manganate, lithium iron phosphate, lithium vanadium phosphate and silicon oxide, and the hydrocarbon group optionally having a substituent includes a fluoroalkyl group.
[10] The composite particle according to [6], in which the inorganic particle is a particle containing at least one inorganic substance selected from the group consisting of titanium oxide, calcium titanate, strontium titanate, calcium zirconate, strontium zirconate, magnesium titanate and barium titanate, and the hydrocarbon group optionally having a substituent includes a hydrocarbon group or alkyl group having a hydroxy group as a substituent.
[11] The composite particle according to [6], in which the inorganic particle is a particle containing at least one inorganic substance selected from the group consisting of lead zirconate titanate, barium titanate, sodium bismuth titanate, zinc oxide and sodium potassium niobate, and the hydrocarbon group optionally having a substituent includes a fluoroalkyl group.

### Advantageous Effects of Invention

According to the present invention, it becomes possible to provide a composite particle containing graphene oxide particles and an inorganic particle where the acidity of the graphene oxide particles can be kept low and the affinity of the composite particle to resins is high.

### BRIEF DESCRIPTION OF DRAWINGS

FIG. 1 is a cross-sectional view of a composite particle according to one embodiment of the present invention.

### DESCRIPTION OF EMBODIMENTS

Hereinafter, the present invention will be described in detail with appropriate reference to the drawing. In the drawing to be used in the following description, there is a case where a characteristic portion is shown in an enlarged manner for convenience in order to facilitate the understanding of the characteristics of the present invention. Therefore, the dimensional ratio and the like of each configuration element shown in the drawing are different from actual ones in some cases. A material, a dimension, and the like provided in the following description are simply exemplary examples, and the present invention is not limited thereto and can be appropriately modified and carried out within the scope of the gist of the present invention.

A composite particle according to an embodiment of the present invention is excellent in terms of dispersibility in resins or organic solvents. Therefore, the composite particle according to the embodiment of the present invention can be used as, for example, an inorganic filler for resin compositions. In addition, the composite particle of the present embodiment can be used as a magnetic material, an electrode active material for batteries, a dielectric material and a piezoelectric material depending on the kind of an inorganic particle.

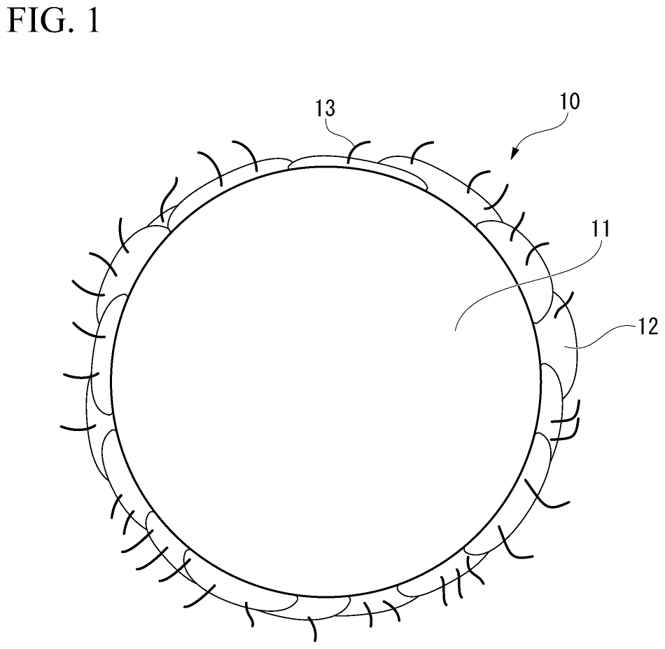

FIG. 1 is a cross-sectional view of the composite particle according to one embodiment of the present invention.

A composite particle 10 shown in FIG. 1 includes an inorganic particle 11 and graphene oxide particles 12 that coat the inorganic particle 11. The graphene oxide particles each have a surface modified with hydrocarbon groups 13 each optionally having a substituent. “Hydrocarbon group 13 optionally having a substituent” in the present embodiment means at least one of “a hydrocarbon group 13 having a substituent” and “a hydrocarbon group 13 not having a substituent”.

The shape of the inorganic particle 11 is not particularly limited. The inorganic particle may have, for example, a spherical shape, an elliptical sphere shape, a cylindrical shape or a prismatic shape. The average particle diameter of the inorganic particle may be in a range of, for example, 0.2 μm or more and 100 μm or less and is preferably in a range of 0.2 μm or more and 60 μm or less. The average particle diameter of the inorganic particle 11 is a value measured with a laser diffraction/scattering type particle size distribution measuring instrument.

The inorganic particle 11 may be, for example, any of a ceramic particle, a metal particle and a metal oxide particle. The metal particle may be a metal particle composed of only one kind of metal or may be an alloy particle containing two or more kinds of metals. The inorganic particle 11 may contain, for example, at least one element obtained from the group consisting of Li, B, N, Na, Mg, Al, Si, P, K, Ca, Ti, V, Mn, Fe, Co, Ni, Cu, Zu, Sr, Zr, Nb, Ag, Sn, Ba, Bi, Nd and Sm.

The kind of the inorganic particle 11 can be selected depending on the intended use of the composite particle 10. In a case where the composite particle 10 is used as an inorganic filler for a resin composition, a particle containing an inorganic substance having high heat resistance and an excellent heat conductive property can be used as the inorganic particle 11. Specifically, for example, a particle containing an inorganic substance such as boron nitride, aluminum nitride, aluminum oxide, magnesium oxide or silicon oxide can be used. The inorganic particle 11 may be a single substance containing any one of these inorganic substances solely or a composite containing two or more thereof. The inorganic particle 11 may contain 80 mass % or more of the inorganic substance or may contain only the inorganic substance.

In addition, in a case where the composite particle 10 is used as a magnetic material, a particle containing a magnetic substance having a magnetic property can be used as the inorganic particle 11. Specifically, for example, a particle containing a magnetic substance such as iron oxide, an Fe—Si alloy, an Fe—Ni alloy, an Fe—Si—Al alloy or manganese monoxide can be used. The inorganic particle 11 may be a single substance containing any one of these magnetic substances solely or a composite containing two or more thereof. The inorganic particle 11 may contain 80 mass % or more of the magnetic substance or may contain only the magnetic substance.

In addition, in a case where the composite particle 10 is used as an electrode active material for a battery, a particle containing an electrode active material for a well-known battery such as a lithium-ion secondary battery can be used as the inorganic particle 11. Specifically, for example, a particle containing an electrode active material such as lithium cobalt oxide, lithium manganate, lithium iron phosphate, lithium vanadium phosphate or silicon oxide can be used. The inorganic particle 11 may be a single substance containing any one of these electrode active materials solely or a composite containing two or more thereof. The inorganic particle 11 may contain 80 mass % or more of the electrode active material or may contain only the electrode active material. The composite particle 10 containing lithium cobalt oxide, lithium manganate, lithium iron phosphate or lithium vanadium phosphate can be used as a positive electrode active material for a lithium secondary battery, and the composite particle 10 containing silicon oxide can be used as a negative electrode active material for a lithium secondary battery.

In addition, in a case where the composite particle 10 is used as a dielectric substance, a particle containing a dielectric substance having a high relative permittivity can be used as the inorganic particle 11. Specifically, for example, a particle containing a dielectric substance such as titanium oxide, calcium titanate, strontium titanate, calcium zirconate, strontium zirconate, magnesium titanate or barium titanate can be used. The inorganic particle 11 may be a single substance containing any one of these dielectric substances solely or a composite containing two or more thereof. The inorganic particle 11 may contain 80 mass % or more of the dielectric substance or may contain only the dielectric substance.

In addition, in a case where the composite particle 10 is used as a piezoelectric material, a particle containing a piezoelectric substance having a piezoelectric property can be used as the inorganic particle 11. Specifically, for example, a particle containing a dielectric substance such as lead zirconate titanate, barium titanate, sodium bismuth titanate, zinc oxide or sodium potassium niobate can be used. The inorganic particle 11 may be a single substance containing any one of these piezoelectric substances solely or a composite containing two or more thereof. The inorganic particle 11 may contain 80 mass % or more of the piezoelectric substance or may contain only the piezoelectric substance.

The graphene oxide particles 12 are, for example, a graphite sheet to which a functional group such as a carboxy group, a hydroxyl group a carbonyl group or an epoxy group bonds. The average thickness of the graphene oxide particles 12 may be in a range of, for example, 0.8 nm or more and 20 nm or less and is preferably in a range of 0.8 nm or more and 5 nm or less. In addition, the average of the longest diameters (average longest diameter) in a surface direction going straight to the thickness direction is, for example, preferably in a range of 0.1 or more and 1 or less and more preferably in a range of 0.3 or more and 0.7 or less when the average particle diameter of the inorganic particle 11 is set to 1.

The coating rate of the graphene oxide particles 12 with respect to the inorganic particle 11 is preferably 80% or more and 100% or less and more preferably 90% or more and 100% or less. The graphene oxide particles 12 may not coat the entire inorganic particle 11.

The hydrocarbon group 13 that modifies the graphene oxide particles 12 may be a saturated hydrocarbon group or may be an unsaturated hydrocarbon group. The hydrocarbon group 13 may have a branch or may form a hydrocarbon ring. The number of carbon atoms in the hydrocarbon group 13 is preferably in a range of 3 or more and 12 or less. Examples of the hydrocarbon group 13 include a phenyl group, an alkyl group, an alkenyl group, an alkynyl group, an aryl group and an aralkyl group. In a case where the hydrocarbon group 13 is a phenyl group, the thermal conductivity improves, which is preferable.

The hydrocarbon group 13 may have a substituent. Examples of the substituent include a halogen atom (a fluorine atom in particular), a hydroxy group, an epoxy group, a glycidoxy group, a (meth)acryloyl group, an amino group, a ureido group, an isocyanate group, a mercapto group and the like.

The graphene oxide particle 12 and the hydrocarbon group 13 may bond to each other through an ether bond: *—C(═O)—O— or a *—C(═O)—O—Si— bond or an amide bond: *—C(═O)—NH— (* indicates a bonding site to which a carbon atom in the graphene oxide particle 12 bonds).

The kind of the hydrocarbon group 13 can be selected depending on the intended use of the composite particle 10. In a case where the composite particle 10 is used as an inorganic filler for a resin composition, a group having a high affinity to resins can be used as the hydrocarbon group 13. As the hydrocarbon group 13, for example, an alkyl group having an epoxy group or an amino group as a substituent can be used.

In addition, in a case where the composite particle 10 is used as a magnetic material, a group having a high affinity to resin materials that are used as binders for magnetic materials (for example, polyvinyl butyral (PVB) or polyvinyl alcohol (PVA)) can be used as the hydrocarbon group 13. Examples of the hydrocarbon group 13 include groups including a hydrocarbon group or alkyl group having a hydroxy group or an amino group as a substituent. Examples of the hydrocarbon group having a hydroxy group as a substituent include a hydroxyalkyl group and a phenol group.

In addition, in a case where the composite particle 10 is used as an electrode active material for batteries, a group having a high affinity to resin materials that are used as binders for electrode active materials (for example, fluororesins such as polyvinylidene fluoride (PVDF)) can be used as the hydrocarbon group 13. Examples of the hydrocarbon group 13 include groups including a fluoroalkyl group.

In addition, in a case where the composite particle 10 is used as a dielectric material, a group having a high affinity to resin materials that are used as binders for dielectric materials (for example, polyvinyl butyral (PVB) or polyvinyl alcohol (PVA)) can be used as the hydrocarbon group 13. Examples of the hydrocarbon group 13 include groups including a hydrocarbon group or alkyl group having a hydroxy group or an amino group as a substituent. Examples of the hydrocarbon group having a hydroxy group as a substituent include a hydroxyalkyl group and a phenol group.

In addition, in a case where the composite particle 10 is used as a piezoelectric material, a group having a high affinity to resin materials that are used as binders for piezoelectric materials (for example, fluororesins such as polyvinylidene fluoride (PVDF)) can be used as the hydrocarbon group 13. Examples of the hydrocarbon group 13 include groups including a fluoroalkyl group.

The composite particle 10 according to the present embodiment can be manufactured, for example, as described below. First, the surface of the inorganic particle 11 is coated with the graphene oxide particles 12 (coating step). Next, the graphene oxide particles 12 on the inorganic particle 11 coated with the graphene oxide particles 12 are surface-treated with a surface treatment agent having a hydrocarbon group to modify the surfaces of the graphene oxide particles 12 with the hydrocarbon group (surface treatment step).

In the coating step, the graphene oxide particles 12 are adsorbed to the surface of the inorganic particle 11 by, for example, stirring and mixing the inorganic particle 11 and the graphene oxide particles 12 in an organic solvent. Next, the organic solvent and a solid matter are separated into solid and liquid, and the solid matter is recovered and dried, whereby the inorganic particle 11 coated with the graphene oxide particles 12 can be obtained. As the organic solvent, for example, an alcohol or a ketone can be used.

In the surface treatment step, the functional groups of the graphene oxide particles 12 and the surface treatment agent are reacted with each other by, for example, bringing the inorganic particle 11 coated with the graphene oxide particles 12 and the surface treatment agent into contact with each other in an organic solvent. Therefore, the functional groups of the graphene oxide particles 12 and the surface treatment agent are bonded to each other. Next, the organic solvent and a solid matter are separated into solid and liquid, and the solid matter is recovered and dried, whereby the composite particle 10 can be obtained.

As the surface treatment agent, a compound having a group that reacts with and bonds to the hydrocarbon groups 13 and the functional groups of the graphene oxide particles 12 can be used. Examples of the group that reacts with the functional groups (carboxy groups in particular) of the graphene oxide particles 12 include a hydroxy group, a silanol group and an amino group. As the surface treatment agent, an alcohol (a monovalent alcohol or a divalent alcohol), a silane compound that generates a silanol group by hydrolysis (silane coupling agent) or an amine can be used. The use of an alcohol as the surface treatment agent makes it possible to obtain the composite particle 10 in which the graphene oxide particles 12 and the hydrocarbon groups 13 bond to each other through ester bonds. In addition, the use of a silane compound as the surface treatment agent makes it possible to obtain the composite particle 10 in which the graphene oxide particles 12 and the hydrocarbon groups 13 bond to each other through —C(═O)—O—Si— bonds. In addition, the use of an amine as the surface treatment agent makes it possible to obtain the composite particle 10 in which the graphene oxide particles 12 and the hydrocarbon groups 13 bond to each other through amide bonds.

In the composite particle 10 according to the present embodiment, the surfaces of the graphene oxide particles 12 coating the inorganic particle 11 are modified with the hydrocarbon groups 13 each optionally having a substituent. Therefore, the surfaces of the graphene oxide particles 12 are less likely to come into contact with moisture, which makes it possible to keep the acidity of the graphene oxide particle 12 low. In addition, the functional groups (carboxy groups in particular) on the surfaces of the graphene oxide particles 12 are modified, which keeps the functional groups on the surfaces of the graphene oxide particles 12 from reacting with a basic substance to form a salt. For these reasons, the composite particle 10 of the present embodiment can be applied to a variety of resins. Examples of resins to which the composite particle 10 of the present embodiment can be applied include, for example, epoxy resins, polyester resins, polycarbonate resins, acrylic resins, polystyrene resins, polyamide resins, vinyl chloride resins, olefin resins, fluororesins, polyvinylidene fluoride resins, polyvinyl acetate resins, polyurethane resins, acrylonitrile butadiene styrene resins, polyvinyl acetal resins, polyvinyl butyral resins, acrylonitrile-styrene copolymer resins, ethylene-vinyl acetate copolymer resins, phenolic resins, melamine resins, urea resins, unsaturated polyester resins, alkyd resins, polyimide resins and silicone resins.

In a case where the inorganic particle 11 includes at least one particle selected from the group consisting of a ceramic particle, a metal particle and a metal oxide particle in the composite particle 10 of the present embodiment, these particles have a high affinity to the graphene oxide particle 12. Therefore, even in a case where the inorganic particle 11 itself has low adhesiveness to resins, adhesiveness to resins can be improved. In addition, in a case where the coating rate of the graphene oxide particles 12 is 80% or more in the composite particle 10 of the present embodiment, the affinity of the composite particle 10 to resins by the graphene oxide particles 12 becomes higher, and the dispersibility in resins further improves. In addition, in a case where the number of carbon atoms in the hydrocarbon group is in a range of 3 or more and 12 or less in the composite particle 10 of the present embodiment, it is possible to improve the affinity to resins or the dispersibility in resins while the acidity of the graphene oxide particle 12 is reliably kept low.

In the composite particle 10 of the present embodiment, a variety of particles containing at least one element obtained from the group consisting of Li, B, N, Na, Mg, Al, Si, P, K, Ca, Ti, V, Mn, Fe, Co, Ni, Cu, Zu, Sr, Zr, Nb, Ag, Sn, Ba, Bi, Nd and Sm can be used as the inorganic particle 11. Therefore, the composite particle 10 of the present embodiment can be applied to a variety of uses.

In a case where the inorganic particle 11 is a particle containing at least one inorganic substance selected from the group consisting of boron nitride, aluminum nitride, aluminum oxide, magnesium oxide and silicon oxide and the hydrocarbon group 13 includes an alkyl group having a glycidoxy group in the composite particle 10 of the present embodiment, the inorganic particle 11 has high heat resistance and an excellent heat conductive property, and the hydrocarbon group 13 has a high affinity to resins. Therefore, the composite particle can be advantageously used as an inorganic filler for resin compositions.

In a case where the inorganic particle 11 is a particle containing at least one inorganic substance selected from the group consisting of iron oxide, an Fe—Si alloy, an Fe—Ni alloy, an Fe—Si—Al alloy and manganese monoxide and the hydrocarbon group 13 includes a hydrocarbon group or alkyl group having a hydroxy group as a substituent in the composite particle 10 of the present embodiment, the inorganic particle 11 has a magnetic property, and the hydrocarbon group 13 has a high affinity to resin materials that are used as binders for magnetic materials. Therefore, the composite particle can be advantageously used as a magnetic material.

In a case where the inorganic particle 11 is a particle containing at least one inorganic substance selected from the group consisting of lithium cobalt oxide, lithium manganate, lithium iron phosphate, lithium vanadium phosphate and silicon oxide and the hydrocarbon group 13 includes a fluoroalkyl group in the composite particle 10 of the present embodiment, the inorganic particle 11 is an electrode active material for lithium-ion secondary batteries, and the hydrocarbon group 13 has a high affinity to resin materials that are used as binders for electrode active materials. Therefore, the composite particle can be advantageously used as an electrode active material for lithium-ion secondary batteries.

In a case where the inorganic particle 11 is a particle containing at least one inorganic substance selected from the group consisting of titanium oxide, calcium titanate, strontium titanate, calcium zirconate, strontium zirconate, magnesium titanate and barium titanate and the hydrocarbon group 13 includes a hydrocarbon group or alkyl group having a hydroxy group as a substituent in the composite particle 10 of the present embodiment, the inorganic particle 11 has a high relative permittivity, and the hydrocarbon group 13 has a high affinity to resin materials that are used as binders for dielectric materials. Therefore, the composite particle can be advantageously used as a dielectric material.

In a case where the inorganic particle 11 is a particle containing at least one inorganic substance selected from the group consisting of lead zirconate titanate, barium titanate, sodium bismuth titanate, zinc oxide and sodium potassium niobate and the hydrocarbon group 13 includes a fluoroalkyl group in the composite particle 10 of the present embodiment, the inorganic particle 11 has a piezoelectric property, and the hydrocarbon group 13 has a high affinity to resin materials that are used as binders for piezoelectric materials. Therefore, the composite particle can be advantageously used as a piezoelectric material.

Hitherto, the embodiment of the present invention has been described in detail with reference to the drawing, but each configuration in each embodiment, a combination thereof, and the like are examples, and the addition, omission, substitution and other modification of the configuration are possible within the scope of the gist of the present invention.

### EXAMPLES

### Example 1

One gram of hexagonal boron nitride particles (UHP1-K, manufactured by Showa Denko K.K.) were added to 70 mL of methyl ethyl ketone and stirred with a homogenizer for five minutes to prepare a hexagonal boron nitride particle dispersion liquid. In addition, methyl ethyl ketone and graphene oxide were mixed to prepare a graphene oxide dispersion liquid having a concentration of 1 mass %.

0.2 mL of the obtained graphene oxide particle dispersion liquid was added to and mixed with the obtained hexagonal boron nitride particle dispersion liquid, and an obtained liquid mixture was further stirred with a mechanical stirrer for 10 minutes. After the stirring, the liquid mixture was left to stand to precipitate a solid matter, and the solid matter was recovered by decantation and dried in a vacuum at 60° C. for 24 hours. Boron nitride particles coated with graphene oxide particles were manufactured as described above.

0.65 g of 3-glycidoxypropyltrimethoxysilane (silane coupling agent: KBM-403, manufactured by Shin-Etsu Chemical Co., Ltd.), 8 mL of pure water and 72 mL of 2-propanol were stirred and mixed at 60° C. for one hour to prepare a 3-glycidoxypropyltrimethoxysilane solution. One gram of the hexagonal boron nitride particles coated with the graphene oxide particles were added to the obtained 3-glycidoxypropyltrimethoxysilane solution and stirred at 70° C. for three hours to surface-treat the graphene oxide particles. An obtained mixture was naturally cooled to room temperature, and a solid matter was recovered by suction filtration. The recovered solid matter was dried in a vacuum at 100° C. for one hour to obtain composite particles.

### Example 2

Methyl ethyl ketone and graphene oxide were mixed to prepare a graphene oxide dispersion liquid having a concentration of 1 mass %. Boron nitride particles coated with graphene oxide particles were manufactured in the same manner as in Example 1 except that 1 mL of the obtained graphene oxide dispersion liquid was added to and mixed with the hexagonal boron nitride particle dispersion liquid, and then the graphene oxide particles were surface-treated to obtain composite particles. As a surface treatment agent, 3-glycidoxypropyltrimethoxysilane was used.

### Example 2-1

Composite particles were obtained in the same manner as in Example 2 except that agglomerate powder boron nitride particles were used as the inorganic particles that were to be coated with the graphene oxide particles. The agglomerate powder boron nitride particles were obtained by the following procedure.

One gram of agglomerate powder boron nitride (PTX25, manufactured by Momentive) was added to 70 mL of methyl ethyl ketone and stirred with a homogenizer for five minutes. After that, 1 mL of a graphene oxide dispersion liquid adjusted to 1 wt % was added to methyl ethyl ketone, and an obtained solution was stirred with a magnetic stirrer for 10 minutes. A precipitate was removed from the stirred solution and dried in a vacuum at 60° C. for 24 hours, thereby obtaining agglomerate powder boron nitride particles coated with graphene oxide. 0.65 g of 3-glycidoxypropyltrimethoxysilane (KBM-403, manufactured by Shin-Etsu Chemical Co., Ltd.), 8 mL of pure water and 72 mL of 2-propanol were stirred at 60° C. for one hour, and 1 g of the previously-produced agglomerate powder boron nitride particles 1 coated with the graphene oxide were added and stirred at 70° C. for three hours. An obtained mixture was filtered by suction filtration and then dried in a vacuum at 100° C. for one hour, thereby obtaining agglomerate powder boron nitride coated with modified graphene oxide.

### Example 2-2

Composite particles were obtained in the same manner as in Example 2 except that, as the surface treatment agent, N-phenyl-3-aminopropyltrimethoxysilane was used instead of 3-glycidoxypropyltrimethoxysilane.

### Example 2-3

Composite particles were obtained in the same manner as in Example 2 except that, as the surface treatment agent, trimethoxyphenylsilane was used instead of 3-glycidoxypropyltrimethoxysilane.

### Example 2-4

Composite particles were obtained in the same manner as in Example 2 except that, as the surface treatment agent, phenethyl alcohol was used instead of 3-glycidoxypropyltrimethoxysilane.

### Example 2-5

Composite particles were obtained in the same manner as in Example 2 except that, as the surface treatment agent, phenyl isocyanate was used instead of 3-glycidoxypropyltrimethoxysilane.

### Example 2-6

Composite particles were obtained in the same manner as in Example 2-1 except that, as the surface treatment agent, trimethoxyphenylsilane was used instead of 3-glycidoxypropyltrimethoxysilane.

### Example 3

Aluminum oxide particles coated with graphene oxide particles were manufactured in the same manner as in Example 1 except that the same amount of aluminum oxide particles (CB-P10, manufactured by Showa Denko K.K.) were used instead of the hexagonal boron nitride particles, and then the graphene oxide particles were surface-treated to obtain composite particles.

### Example 3-1

Composite particles were obtained in the same manner as in Example 3 except that, as the surface treatment agent, N-phenyl-3-aminopropyltrimethoxysilane was used instead of 3-glycidoxypropyltrimethoxysilane.

### Example 3-2

Composite particles were obtained in the same manner as in Example 3 except that, as the surface treatment agent, trimethoxyphenylsilane was used instead of 3-glycidoxypropyltrimethoxysilane.

### Example 3-3

Composite particles were obtained in the same manner as in Example 3 except that, as the surface treatment agent, phenethyl alcohol was used instead of 3-glycidoxypropyltrimethoxysilane.

### Example 3-4

Composite particles were obtained in the same manner as in Example 3 except that, as the surface treatment agent, phenyl isocyanate was used instead of 3-glycidoxypropyltrimethoxysilane.

### Example 4

Magnesium oxide particles coated with graphene oxide particles were manufactured in the same manner as in Example 1 except that the same amount of magnesium oxide particles (PYROKISUMA 5301K, Kyowa Chemical Corporation) were used instead of the hexagonal boron nitride particles, and then the graphene oxide particles were surface-treated to obtain composite particles.

### Example 4-1

Composite particles were obtained in the same manner as in Example 4 except that, as the surface treatment agent, N-phenyl-3-aminopropyltrimethoxysilane was used instead of 3-glycidoxypropyltrimethoxysilane.

### Example 4-2

Composite particles were obtained in the same manner as in Example 4 except that, as the surface treatment agent, trimethoxyphenylsilane was used instead of 3-glycidoxypropyltrimethoxysilane.

### Example 4-3

Composite particles were obtained in the same manner as in Example 4 except that, as the surface treatment agent, phenethyl alcohol was used instead of 3-glycidoxypropyltrimethoxysilane.

### Example 4-4

Composite particles were obtained in the same manner as in Example 4 except that, as the surface treatment agent, phenyl isocyanate was used instead of 3-glycidoxypropyltrimethoxysilane.

### Example 5

Ferrite particles coated with graphene oxide particles were manufactured in the same manner as in Example 1 except that the same amount of ferrite particles were used instead of the hexagonal boron nitride particles.

20 mL of 1,4-butanediol and 1 g of the ferrite particles coated with the graphene oxide particles were added to 20 mL of N,N-dimethylformamide (DMF) and stirred and mixed for 30 minutes. An obtained liquid mixture was stirred for three hours while being held at 60° C. Next, N,N′-dicyclohexylcarbodiimide and 1-hydroxybenzotriazole were added to the liquid mixture as catalysts and further stirred for 24 hours while the temperature was maintained at 60° C. to surface-treat the graphene oxide particles. After that, the liquid mixture was slowly cooled to room temperature over 24 hours under stirring. The slowly-cooled liquid mixture was centrifuged to recover a solid matter, and the obtained solid matter was repeatedly washed three times with DMF, 8 wt % of sodium bicarbonate water and pure water in order and then filtered by vacuum filtration. The washed solid matter was dried in a vacuum at 80° C. for 24 hours to obtain composite particles.

### Example 6

FeSiCr particles coated with graphene oxide particles were manufactured in the same manner as in Example 5 except that the same amount of FeSiCr particles (FSC-2K(C), manufactured by Sintokogio, Ltd.) were used instead of the ferrite particles, and then the graphene oxide particles were surface-treated to obtain composite particles.

### Example 7

Manganese monoxide particles coated with graphene oxide particles were manufactured in the same manner as in Example 5 except that the same amount of manganese monoxide particles (manufactured by Kojundo Chemical Laboratory Co., Ltd.) were used instead of the ferrite particles, and then the graphene oxide particles were surface-treated to obtain composite particles.

### Example 8

Barium titanate particles coated with graphene oxide particles were manufactured in the same manner as in Example 5 except that the same amount of barium titanate particles were used instead of the ferrite particles, and then the graphene oxide particles were surface-treated to obtain composite particles.

### Example 9

Lithium cobalt oxide particles coated with graphene oxide particles were manufactured in the same manner as in Example 5 except that the same amount of lithium cobalt oxide particles (manufactured by Kojundo Chemical Laboratory Co., Ltd.) were used instead of the ferrite particles. Next, the graphene oxide particles were surface-treated in the same manner as in Example 5 except that the same amount of 2,2,3,4,4,4-hexafluoro-1-butanol was used instead of 1,4-butanediol to obtain composite particles.

### Example 10

Silicon oxide particles coated with graphene oxide particles were manufactured in the same manner as in Example 9 except that the same amount of silicon oxide particles (HS-206, manufactured by Nippon Steel Chemical & Material Co., Ltd.) were used instead of the lithium cobalt oxide particles, and then the graphene oxide particles were surface-treated to obtain composite particles.

### Example 11

Vanadium phosphate particles coated with graphene oxide particles were manufactured in the same manner as in Example 9 except that the same amount of lithium vanadium phosphate particles were used instead of the lithium cobalt oxide particles, and then the graphene oxide particles were surface-treated to obtain composite particles.

### Example 12

Composite particles were obtained in the same manner as in Example 2 except that the same amount of 8-glycidoxyoctyltrimethoxysilane (silane coupling agent: KBM-4803, manufactured by Shin-Etsu Chemical Co., Ltd.) was used instead of 3-glycidoxypropyltrimethoxysilane.

### Example 13

Composite particles were obtained in the same manner as in Example 12 except that the same amount of the aluminum oxide particles coated with graphene oxide particles manufactured in Example 3 were used instead of the hexagonal boron nitride particles coated with the graphene oxide particles.

### Example 14

Composite particles were obtained in the same manner as in Example 14 except that the same amount of the aluminum oxide particles coated with graphene oxide particles manufactured in Example 4 were used instead of the hexagonal boron nitride particles coated with the graphene oxide particles.

### Example 15

Graphene oxide particles of ferrite particles coated with graphene oxide particles were surface-treated to obtain composite particles in the same manner as in Example 5 except that the same amount of 1,8-oditanediol was used instead of 1,4-butanediol.

### Example 16

Composite particles were obtained in the same manner as in Example 15 except that the same amount of FeSiCr particles coated with graphene oxide manufactured in Example 6 were used instead of the ferrite particles coated with the graphene oxide particles.

### Example 17

Composite particles were obtained in the same manner as in Example 15 except that the same amount of manganese monoxide particles coated with graphene oxide manufactured in Example 7 were used instead of the ferrite particles coated with the graphene oxide particles.

### Example 18

Composite particles were obtained in the same manner as in Example 15 except that the same amount of barium titanate particles coated with graphene oxide manufactured in Example 8 were used instead of the ferrite particles coated with the graphene oxide particles.

### Example 19

Composite particles were obtained in the same manner as in Example 9 except that the same amount of 1H,1H-tricosafluoro-1-dodecanol was used instead of 2,2,3,4,4,4-hexafluoro-1-butanol.

### Example 20

Composite particles were obtained in the same manner as in Example 10 except that the same amount of 1H,1H-tricosafluoro-1-dodecanol was used instead of 2,2,3,4,4,4-hexafluoro-1-butanol.

### Example 21

Composite particles were obtained in the same manner as in Example 11 except that the same amount of 1H,1H-tricosafluoro-1-dodecanol was used instead of 2,2,3,4,4,4-hexafluoro-1-butanol.

### Example 22

One gram of the barium titanate coated with graphene oxide particles manufactured in Example 8 was added to 20 m of N,N-dimethylformamide (DMF) and stirred and mixed at room temperature for 30 minutes in a nitrogen atmosphere. After that, 0.2 g of sodium hydroxide was added and stirred for one hour to mix the sodium hydroxide with the solution. Next, 0.2 g of 5-amino-1-pentanol, 0.26 g of 1-hydroxybenzotriazole and 0.4 g of N,N′-dicyclohexylcarbodiimide were added and stirred for 24 hours to mix them with the solution. An obtained mixture was centrifuged to recover a solid matter, and the obtained solid matter was washed with DMF. The washed solid matter was dried in a vacuum at 60° C. for 24 hours to obtain composite particles.

### Comparative Example 1

The hexagonal boron nitride particles coated with the graphene oxide particles manufactured in Example 1 in which the graphene oxide particles were not surface-treated were used as composite particles of Comparative Example 1.

### Comparative Example 2

The aluminum oxide particles coated with the graphene oxide particles manufactured in Example 3 in which the graphene oxide particles were not surface-treated were used as composite particles of Comparative Example 2.

### Comparative Example 3

The magnesium oxide particles coated with the graphene oxide particles manufactured in Example 4 in which the graphene oxide particles were not surface-treated were used as composite particles of Comparative Example 3.

### Comparative Example 4

The ferrite particles coated with the graphene oxide particles manufactured in Example 5 in which the graphene oxide particles were not surface-treated were used as composite particles of Comparative Example 4.

### Comparative Example 5

The FeSiCr particles coated with the graphene oxide particles manufactured in Example 6 in which the graphene oxide particles were not surface-treated were used as composite particles of Comparative Example 5.

### Comparative Example 6

The manganese monoxide particles coated with the graphene oxide particles manufactured in Example 7 in which the graphene oxide particles were not surface-treated were used as composite particles of Comparative Example 6.

### Comparative Example 7

The barium titanate particles coated with the graphene oxide particles manufactured in Example 8 in which the graphene oxide particles were not surface-treated were used as composite particles of Comparative Example 7.

### Comparative Example 8

The lithium cobalt oxide coated with the graphene oxide particles manufactured in Example 9 in which the graphene oxide particles were not surface-treated were used as composite particles of Comparative Example 8.

### Comparative Example 9

The silicon oxide particles coated with the graphene oxide particles manufactured in Example 10 in which the graphene oxide particles were not surface-treated were used as composite particles of Comparative Example 9.

### Comparative Example 10

The lithium vanadium phosphate particles coated with the graphene oxide particles manufactured in Example 11 in which the graphene oxide particles were not surface-treated were used as composite particles of Comparative Example 10.

### Evaluation

Regarding the composite particles obtained in Examples 1 to 22, Comparative Examples 1 to 10, Examples 2-1 to 2-6, 3-1 to 3-4 and 4-1 to 4-4, the following evaluation was performed. The results are shown in Tables 1 and 2 below together with the kinds and average particle diameters of the inorganic particles and the average thicknesses and average longest diameters of the graphene oxides that were contained in the composite particles.
(1) Coating Rate

The Raman spectra of the composite particles were measured using a laser Raman microspectrophotometer (NRS-7100, manufactured by JASCO Corporation). Raman spectra were measured at 100 arbitrary places where a band derived from the inorganic particle was confirmed, and the number of places where a band of 1574 cm⁻¹ derived from the graphene oxide was confirmed from the obtained Raman spectra was measured as places coated with graphene oxide particles. In addition, the coating rate (%) of the graphene oxide particles was obtained by the following formula.

Coating rate of graphene oxide particles=n/100×100

(Here, n is the number of places where a band of 1574 cm⁻¹ derived from the graphene oxide was confirmed.)
(2) Presence or Absence of Hydrocarbon Groups

The infrared absorption spectrum of the surface of the composite particle was measured. The infrared absorption spectrum was measured using FT-IR (Nicolet iS50, manufactured by Thermo Fisher Scientific Inc.) by a diffuse reflection method. The measurement range of the infrared absorption spectrum was set to 500 to 3500 cm⁻¹. In a case where infrared absorption peaks were shown at wavelengths of near 1100 cm⁻¹ or near 1578 cm⁻¹ and 1630 cm⁻¹, the hydrocarbon groups were evaluated as “present”, and, in a case where no infrared absorption peaks were shown at those wavelengths, the hydrocarbon groups were evaluated as “absent”.
(3) Carboxy Group Equivalent (Acidity)

Ten grains of a sodium bicarbonate aqueous solution having a concentration of 0.05 mmoL/g was added to 5 g of the composite particles and stirred for 48 hours. Five grams of a supernatant liquid was collected, and the neutralization titration of the collected supernatant liquid was performed with a hydrochloric acid aqueous solution having a concentration of 0.05 moL/L. For the neutralization titration, a potentiometric titrator AT-610 from Kyoto Electronics Manufacturing Co., Ltd. was used. In addition, the volume of the hydrochloric acid aqueous solution necessary for the neutralization of this supernatant liquid was represented by X (unit: mL) and converted to the carboxy group equivalent of the composite particle by the following formula.

Carboxy group equivalent (mmoL/g)=concentration of sodium bicarbonate aqueous solution (0.05 mmoL/g)−[{hydrochloric acid aqueous solution concentration (0.05 moL/L)×volume (X mL) of hydrochloric acid aqueous solution necessary for neutralization/mass of supernatant liquid (5 g)}×{mass of sodium bicarbonate aqueous solution (10 g)/mass of composite particle (5 g)}]
(4) Fluidity

A liquid crystalline molecular curing agent represented by the following formula (1) (Mm=2650, Mw=5380) and a trifunctional epoxy compound having a triazine skeleton (TEPIC-S, manufactured by Nissan Chemical Corporation) were mixed in a mass ratio of 4:1. The liquid crystalline molecular curing agent was manufactured by the following method. An obtained epoxy resin composition and the composite particles were weighed so that the content of the composite particles reached 30 vol % and mixed using a mortar and a pestle to obtain a powdery mixture. One gram of the obtained powdery mixture was left to stand on a stainless steel plate and pressed at 120° C. for 30 seconds. The epoxy resin composition in the powdery mixture dissolved by the pressing and cured while spreading in a circular shape, thereby generating a sheet-like cured product. The pressure imparted per unit area of the sheet-like cured product was calculated from the area of the sheet-like cured product obtained by the pressing and the pressure imparted during the pressing. In a case where this pressure was 0.8 MPa or lower, the composite particles in the resin were considered to sufficiently flow and spread, and the fluidity was evaluated as “excellent”, in a case where the pressure was more than 0.8 MPa and 1.0 MPa or lower, the fluidity was evaluated as “good”, and, in a case where the pressure exceeded 1 MPa, the fluidity was evaluated as “poor”.

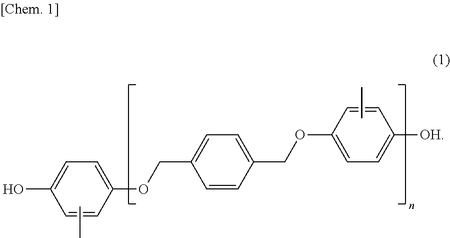

(In the formula (1), n is an integer of 2 to 20.)

### Method for Manufacturing Liquid Crystalline Molecular Curing Agent

Methyl hydroquinone (0.31 mol) and α,α′-dichloro-p-xylene (0.29 mol) were weighed in a three-neck flask and dissolved in 1 L of tetrahydrofuran (THF) to obtain a mixed solution. The mixed solution was refluxed in a nitrogen stream to remove dissolved oxygen in the mixed solution. Next, a sodium hydroxide 50% aqueous solution containing sodium hydroxide (0.7 mol) was added to the mixed solution, and the mixed solution was held in the refluxed state for 12 hours, reacted, and then naturally cooled to room temperature. After the end of the reaction, hydrochloric acid was added to an obtained reaction solution to adjust the pH of the reaction solution to four to six. After that, water was poured into the reaction solution and stirred for 30 minutes, and a generated precipitate was recovered by filtration. The recovered precipitate was washed with 1 L of methyl ethyl ketone (MEK), filtered to recover an insoluble matter and dried in a vacuum for 12 hours or longer, thereby obtaining a compound of the general formula (1).
(5) Dispersibility

The sheet-like cured product obtained for the evaluation of the fluidity in (4) was observed with an optical microscope. In a case where the number of agglomerates in which five or more composite particles agglomerated per square centimeter of the sheet-like cured product was less than two, the dispersibility was evaluated as “favorable”, and, in a case where the number was two or more, the dispersibility was evaluated as “poor”.

TABLE 1

| | Inorganic | | Graphene | | |
|---|---|---|---|---|---|
| | particles | | oxide particles | | |
| | | Average | | Average | |
| | | particle | Average | longest | |
| | | diameter | thickness | diameter | |
| | Kind | (μm) | (nm) | (μm) | Surface treatment agent |
| Example 1 | Boron | 34 | 3.2 | 30 | 3- |
| | nitride | | | | Glycidoxypropyltrimethoxysilane |
| Example 2 | Boron | 34 | 3.2 | 30 | 3- |
| | nitride | | | | Glycidoxypropyltrimethoxysilane |
| Example 3 | Aluminum | 8 | 3.2 | 5 | 3- |
| | oxide | | | | Glycidoxypropyltrimethoxysilane |
| Example 4 | Magnesium | 24 | 3.2 | 5 | 3- |
| | oxide | | | | Glycidoxypropyltrimethoxysilane |
| Example 5 | Ferrite | 18 | 3.2 | 5 | 1,4-Butanediol |
| Example 6 | FeSiCr | 20 | 3.2 | 5 | 1,4-Butanediol |
| Example 7 | Manganese | 8 | 3.2 | 5 | 1,4-Butanediol |
| | monoxide | | | | |
| Example 8 | Barium | 0.6 | 3.2 | 0.5 | 1,4-Butanediol |
| | titanate | | | | |
| Example 9 | Lithium | 40 | 3.2 | 30 | 2,2,3,4,4,4- |
| | cobalt | | | | Hexafluoro-1-butanol |
| | oxide | | | | |
| Example 10 | Silicon | 11 | 3.2 | 5 | 2,2,3,4,4,4- |
| | oxide | | | | Hexafluoro-1-butanol |
| Example 11 | Lithium | 15 | 3.2 | 5 | 2,2,3,4,4,4- |
| | vanadium | | | | Hexafluoro-1-butanol |
| | phosphate | | | | |
| Example 12 | Boron | 34 | 3.2 | 30 | 8- |
| | nitride | | | | Glycidoxyoctyltrimethoxysilane |
| Example 13 | Aluminum | 8 | 3.2 | 5 | 8- |
| | oxide | | | | Glycidoxyoctyltrimethoxysilane |
| Example 14 | Magnesium | 24 | 3.2 | 5 | 8- |
| | oxide | | | | Glycidoxyoctyltrimethoxysilane |
| Example 15 | Ferrite | 18 | 3.2 | 5 | 1,8-oditanediol |
| Example 16 | FeSiCr | 20 | 3.2 | 5 | 1,8-oditanediol |
| Example 17 | Manganese | 8 | 3.2 | 5 | 1,8-oditanediol |
| | monoxide | | | | |
| Example 18 | Barium | 0.6 | 3.2 | 0.5 | 1,8-oditanediol |
| | titanate | | | | |
| Example 19 | Lithium | 40 | 3.2 | 30 | 1H,1H-tricosafluoro-1- |
| | cobalt | | | | dodecanol |
| | oxide | | | | |
| Example 20 | Silica | 11 | 3.2 | 5 | 1H,1H-tricosafluoro-1- |
| | | | | | dodecanol |
| Example 21 | Lithium | 15 | 3.2 | 5 | 1H,1H-tricosafluoro-1- |
| | vanadium | | | | dodecanol |
| | phosphate | | | | |
| Example 22 | Barium | 0.6 | 3.2 | 0.5 | 5-Amino-1-pentanol |
| | titanate | | | | |
| Comparative | Boron | 34 | 3.2 | 30 | — |
| Example 1 | nitride | | | | |
| Comparative | Aluminum | 8 | 3.2 | 5 | — |
| Example 2 | oxide | | | | |
| Comparative | Magnesium | 24 | 3.2 | 5 | — |
| Example 3 | oxide | | | | |
| Comparative | Ferrite | 18 | 3.2 | 5 | — |
| Example 4 | | | | | |
| Comparative | FeSiCr | 20 | 3.2 | 5 | — |
| Example 5 | | | | | |
| Comparative | Manganese | 8 | 3.2 | 5 | — |
| Example 6 | monoxide | | | | |
| Comparative | Barium | 0.6 | 3.2 | 0.5 | — |
| Example 7 | titanate | | | | |
| Comparative | Lithium | 40 | 3.2 | 30 | — |
| Example 8 | cobalt | | | | |
| | oxide | | | | |
| Comparative | Silica | 11 | 3.2 | 5 | — |
| Example 9 | | | | | |
| Comparative | Lithium | 15 | 3.2 | 5 | — |
| Example 10 | vanadium | | | | |
| | phosphate | | | | |

| | Evaluation | | | | |
|---|---|---|---|---|---|
| | | Presence or | Carboxy | | |
| | Coating | absence of | group | | |
| | rate | hydrocarbon | equivalent | | Dispers- |
| | (%) | group | (mmoL/g) | Fluidity | ibility |
| Example 1 | 27 | Present | 0.001 | Favorable | Good |
| Example 2 | 100 | Present | 0.002 | Favorable | Excellent |
| Example 3 | 100 | Present | 0.003 | Favorable | Excellent |
| Example 4 | 85 | Present | 0.001 | Favorable | Excellent |
| Example 5 | 80 | Present | 0.001 | Favorable | Excellent |
| Example 6 | 87 | Present | 0.001 | Favorable | Excellent |
| Example 7 | 100 | Present | 0.002 | Favorable | Excellent |
| Example 8 | 100 | Present | 0.028 | Favorable | Excellent |
| Example 9 | 80 | Present | 0.001 | Favorable | Excellent |
| Example 10 | 100 | Present | 0.003 | Favorable | Excellent |
| Example 11 | 95 | Present | 0.001 | Favorable | Excellent |
| Example 12 | 100 | Present | 0.001 | Favorable | Excellent |
| Example 13 | 100 | Present | 0.003 | Favorable | Excellent |
| Example 14 | 85 | Present | 0.001 | Favorable | Excellent |
| Example 15 | 80 | Present | 0.001 | Favorable | Excellent |
| Example 16 | 87 | Present | 0.001 | Favorable | Excellent |
| Example 17 | 100 | Present | 0.003 | Favorable | Excellent |
| Example 18 | 100 | Present | 0.029 | Favorable | Excellent |
| Example 19 | 80 | Present | 0.001 | Favorable | Excellent |
| Example 20 | 100 | Present | 0.003 | Favorable | Excellent |
| Example 21 | 95 | Present | 0.001 | Favorable | Excellent |
| Example 22 | 100 | Present | 0.030 | Favorable | Excellent |
| Comparative | 100 | Absent | 0.006 | Poor | Poor |
| Example 1 | | | | | |
| Comparative | 100 | Absent | 0.013 | Poor | Poor |
| Example 2 | | | | | |
| Comparative | 85 | Absent | 0.005 | Poor | Poor |
| Example 3 | | | | | |
| Comparative | 80 | Absent | 0.005 | Poor | Poor |
| Example 4 | | | | | |
| Comparative | 87 | Absent | 0.005 | Poor | Poor |
| Example 5 | | | | | |
| Comparative | 100 | Absent | 0.010 | Poor | Poor |
| Example 6 | | | | | |
| Comparative | 100 | Absent | 0.119 | Poor | Poor |
| Example 7 | | | | | |
| Comparative | 80 | Absent | 0.002 | Poor | Poor |
| Example 8 | | | | | |
| Comparative | 100 | Absent | 0.015 | Poor | Poor |
| Example 9 | | | | | |
| Comparative | 95 | Absent | 0.006 | Poor | Poor |
| Example 10 | | | | | |

TABLE 2

| | Inorganic | | Graphene oxide | | |
|---|---|---|---|---|---|
| | particles | | particles | | |
| | | Average | | Average | |
| | | particle | Average | longest | |
| | | diameter | thickness | diameter | |
| | Kind | (μm) | (nm) | (μm) | Surface treatment agent |
| Example 1 | Boron | 34 | 3.2 | 30 | 3- |
| | nitride | | | | Glycidoxypropyltrimethoxysilane |
| Example 2 | Boron | 34 | 3.2 | 30 | 3- |
| | nitride | | | | Glycidoxypropyltrimethoxysilane |
| Example 2-1 | Agglomerate | 25 | 3.2 | 30 | 3- |
| | powder | | | | Glycidoxypropyltrimethoxysilane |
| | boron | | | | |
| | nitride | | | | |
| Example 2-2 | Boron | 34 | 3.2 | 30 | N-phenyl-3- |
| | nitride | | | | aminopropyltrimethoxysilane |
| Example 2-3 | Boron | 34 | 3.2 | 30 | Trimethoxyphenylsilane |
| | nitride | | | | |
| Example 2-4 | Boron | 34 | 3.2 | 30 | Phenethyl |
| | nitride | | | | alcohol |
| Example 2-5 | Boron | 34 | 3.2 | 30 | Phenyl |
| | nitride | | | | isocyanate |
| Example 2-6 | Agglomerate | 25 | 3.2 | 30 | Trimethoxyphenylsilane |
| | powder | | | | |
| | boron | | | | |
| | nitride | | | | |
| Example 3 | Aluminum | 8 | 3.2 | 5 | 3- |
| | oxide | | | | Glycidoxypropyltrimethoxysilane |
| Example 3-1 | Aluminum | 8 | 3.2 | 5 | N-phenyl-3- |
| | oxide | | | | aminopropyltrimethoxysilane |
| Example 3-2 | Aluminum | 8 | 3.2 | 5 | Trimethoxyphenylsilane |
| | oxide | | | | |
| Example 3-3 | Aluminum | 8 | 3.2 | 5 | Phenethyl |
| | oxide | | | | alcohol |
| Example 3-4 | Aluminum | 8 | 3.2 | 5 | Phenyl |
| | oxide | | | | isocyanate |
| Example 4 | Magnesium | 24 | 3.2 | 5 | 3- |
| | oxide | | | | Glycidoxypropyltrimethoxysilane |
| Example 4-1 | Magnesium | 24 | 3.2 | 5 | N-phenyl-3- |
| | oxide | | | | aminopropyltrimethoxysilane |
| Example 4-2 | Magnesium | 24 | 3.2 | 5 | Trimethoxyphenylsilane |
| | oxide | | | | |
| Example 4-3 | Magnesium | 24 | 3.2 | 5 | Phenethyl |
| | oxide | | | | alcohol |
| Example 4-4 | Magnesium | 24 | 3.2 | 5 | Phenyl |
| | oxide | | | | isocyanate |
| Comparative | Boron | 34 | 3.2 | 30 | — |
| Example 1 | nitride | | | | |
| Comparative | Agglomerate | 25 | 3.2 | 30 | — |
| Example 2 | powder | | | | |
| | boron | | | | |
| | nitride | | | | |
| Comparative | Aluminum | 8 | 3.2 | 5 | — |
| Example 2 | oxide | | | | |
| Comparative | Magnesium | 24 | 3.2 | 5 | — |
| Example 3 | oxide | | | | |

| | Evaluation | | | | | |
|---|---|---|---|---|---|---|
| | | Presence or | Carboxy | | | |
| | Coating | absence of | group | | | Thermal |
| | rate | hydrocarbon | equivalent | | Dispers- | conductivity |
| | (%) | group | (g/mmoL) | Fluidity | ibility | (W/mK) |
| Example 1 | 27 | Present | 0.001 | Favorable | Favorable | 1.22 |
| Example 2 | 100 | Present | 0.002 | Favorable | Favorable | 1.28 |
| Example 2-1 | 100 | Present | 0.002 | Favorable | Favorable | 1.37 |
| Example 2-2 | 100 | Present | 0.002 | Favorable | Favorable | 1.55 |
| Example 2-3 | 100 | Present | 0.002 | Favorable | Favorable | 2.03 |
| Example 2-4 | 100 | Present | 0.002 | Favorable | Favorable | 1.63 |
| Example 2-5 | 100 | Present | 0.002 | Favorable | Favorable | 1.98 |
| Example 2-6 | 100 | Present | 0.002 | Favorable | Favorable | 1.81 |
| Example 3 | 100 | Present | 0.003 | Favorable | Favorable | 1.46 |
| Example 3-1 | 100 | Present | 0.003 | Favorable | Favorable | 1.6 |
| Example 3-2 | 100 | Present | 0.003 | Favorable | Favorable | 1.68 |
| Example 3-3 | 100 | Present | 0.003 | Favorable | Favorable | 1.61 |
| Example 3-4 | 100 | Present | 0.003 | Favorable | Favorable | 1.65 |
| Example 4 | 85 | Present | 0.001 | Favorable | Favorable | 1.52 |
| Example 4-1 | 85 | Present | 0.001 | Favorable | Favorable | 1.66 |
| Example 4-2 | 85 | Present | 0.001 | Favorable | Favorable | 1.79 |
| Example 4-3 | 85 | Present | 0.001 | Favorable | Favorable | 1.68 |
| Example 4-4 | 85 | Present | 0.001 | Favorable | Favorable | 1.72 |
| Comparative | 100 | Absent | 0.006 | Poor | Poor | 1.19 |
| Example 1 | | | | | | |
| Comparative | 100 | Present | 0.002 | Poor | Poor | 1.32 |
| Example 2 | | | | | | |
| Comparative | 100 | Absent | 0.013 | Poor | Poor | 1.43 |
| Example 2 | | | | | | |
| Comparative | 85 | Absent | 0.005 | Poor | Poor | 1.49 |
| Example 3 | | | | | | |

Regarding the presence or absence of the hydrocarbon groups, infrared absorption peaks were obtained at near 1100 cm⁻¹ for the composite particles obtained in Example 1 to 4 and 12 to 14. These infrared absorption peaks are considered to be derived from —C(═O)—O—Si—. Therefore, in the composite particles obtained in Examples 1 to 4 and 12 to 14, it is conceivable that the hydrocarbon groups were graft-polymerized with the graphene oxide through —C(═O)—O—Si— bonds generated by a reaction between carboxy groups of the graphene oxide particles and silanol groups generated by the hydrolysis of the silane coupling agent. In addition, infrared absorption peaks were obtained at near 1630 cm⁻1 for the composite particles obtained in Examples 5 to 11 and to 21. These infrared absorption peaks are considered to be derived from ester bonds. Therefore, in the composite particles obtained in Examples 5 to 11 and 15 to 21, it is conceivable that the hydrocarbon groups were graft-polymerized with the graphene oxide particles through ester bonds generated by a reaction between carboxy groups of the graphene oxide particles and an alcohol. Incidentally, infrared absorption peaks were confirmed at near 1630 cm⁻1 and 1578 cm⁻1 for the composite particles obtained in Example 22. These infrared absorption peaks are each considered to be derived from the stretching movement of C═O and the stretching movement of C—N in amide bonds. Therefore, in the composite particles obtained in Example 22, it is conceivable that the hydrocarbon groups were graft-polymerized with the graphene oxide particles through amide bonds generated by a reaction between carboxy groups of the graphene oxide particles and an amine.

From comparison between the composite particles of Examples 1 to 22 coated with the modified graphene oxide particles each having a surface modified with a hydrocarbon group and the composite particles of Comparative Examples 1 to 10 coated with the graphene particles each having a surface not modified with a hydrocarbon group, it was confirmed that, in a case where the inorganic particle was the same, the composite particles of Examples 1 to 22 exhibited low values in terms of the carboxy group equivalent, which is an index of the acidity. In addition, it was confirmed that the composite particles of Examples 1 to 22 were favorable in terms of fluidity and dispersibility and had a high affinity to resins.

From comparison between Example 2 and Examples 2-2 to 2-5, comparison between Example 3 and Examples 3-1 to 3-4 and comparison between Example 4 and Examples 4-1 to 3-4, it was confirmed that, in a case where inorganic particles are the same as each other, the thermal conductivity can be improved when a phenyl group is included in a hydrocarbon group.

In a case where the inorganic particle was boron nitride and a phenyl group was included in the hydrocarbon group, it was possible to improve the thermal conductivity to 1.55 to 2.03. In addition, in a case where the inorganic particle was aluminum oxide and a phenyl group was included in the hydrocarbon group, it was possible to improve the thermal conductivity to 1.6 to 1.68. In addition, in a case where the inorganic particle was magnesium oxide and a phenyl group was included in the hydrocarbon group, it was possible to improve the thermal conductivity to 1.66 to 1.79.

### REFERENCE SIGNS LIST

10 Composite particle
11 Inorganic particle
12 Graphene oxide particle
13 Hydrocarbon group

1. A composite particle comprising:
an inorganic particle; and
graphene oxide particles that coat at least a part of the inorganic particle,
wherein the graphene oxide particles are modified graphene oxide particles having a surface modified with a hydrocarbon group optionally having a substituent.

2. The composite particle according to claim 1,
wherein the inorganic particle includes at least one particle selected from the group consisting of a ceramic particle, a metal particle and a metal oxide particle.

3. The composite particle according to claim 1,
wherein a coating rate of the graphene oxide particles with respect to the inorganic particle is 80% or more.

4. The composite particle according to claim 1,
wherein the number of carbon atoms in the hydrocarbon group optionally having a substituent is in a range of 3 or more and 12 or less.

5. The composite particle according to claim 1,
wherein the hydrocarbon group is a phenyl group.

6. The composite particle according to claim 1,
wherein the inorganic particle contains at least one element obtained from the group consisting of Li, B, N, Na, Mg, Al, Si, P, K, Ca, Ti, V, Mn, Fe, Co, Ni, Cu, Zu, Sr, Zr, Nb, Ag, Sn, Ba, Bi, Nd and Sm.

7. The composite particle according to claim 6,
wherein the inorganic particle is a particle containing at least one inorganic substance selected from the group consisting of boron nitride, aluminum nitride, aluminum oxide, magnesium oxide and silicon oxide, and the hydrocarbon group optionally having a substituent includes an alkyl group having a glycidoxy group.

8. The composite particle according to claim 6,
wherein the inorganic particle is a particle containing at least one inorganic substance selected from the group consisting of iron oxide, an Fe—Si alloy, an Fe—Ni alloy, an Fe—Si—Al alloy and manganese monoxide, and the hydrocarbon group optionally having a substituent includes a hydrocarbon group or alkyl group having a hydroxy group as a substituent.

9. The composite particle according to claim 6,
wherein the inorganic particle is a particle containing at least one inorganic substance selected from the group consisting of lithium cobalt oxide, lithium manganate, lithium iron phosphate, lithium vanadium phosphate and silicon oxide, and the hydrocarbon group optionally having a substituent includes a fluoroalkyl group.

10. The composite particle according to claim 6,
wherein the inorganic particle is a particle containing at least one inorganic substance selected from the group consisting of titanium oxide, calcium titanate, strontium titanate, calcium zirconate, strontium zirconate, magnesium titanate and barium titanate, and the hydrocarbon group optionally having a substituent includes a hydrocarbon group or alkyl group having a hydroxy group as a substituent.

11. The composite particle according to claim 6,
wherein the inorganic particle is a particle containing at least one inorganic substance selected from the group consisting of lead zirconate titanate, barium titanate, sodium bismuth titanate, zinc oxide and sodium potassium niobate, and the hydrocarbon group optionally having a substituent includes a fluoroalkyl group.
